(19) United States
(12) Patent Application Publication
(10) Pub. No.: US 2019/0042083 A1
(43) Pub. Date: Feb. 7, 2019

(54) MANAGING DOCUMENTS WITH SCROLL BOXES

(71) Applicant: LUCID SOFTWARE, INC., South Jordan, UT (US)

(72) Inventors: Benjamin N. Dilts, Bluffdale, UT (US); Alma T. Madsen, Lehi, UT (US); Quinn A. Morgan, Salt Lake City, UT (US); Karl Sun, Draper, UT (US)

(21) Appl. No.: 16/158,114

(22) Filed: Oct. 11, 2018

Related U.S. Application Data
(62) Division of application No. 14/325,060, filed on Jul. 7, 2014.

(51) Int. Cl. G06F 3/0484; G06F 3/0485

(52) U.S. Cl. CPC G06F 3/04847; G06F 3/0485

(57) ABSTRACT

A method may include receiving data indicating a navigation in a scroll box of a document. The method may include determining a scroll offset associated with the navigation. The method may include determining a scroll stop location that corresponds to the scroll offset in the scroll box. The method may include determining whether the scroll stop location is associated with a first stop object in the scroll box. In response to the scroll stop location not being associated with the first stop object, the method may include determining a second stop object preceding the scroll stop location in the scroll box, configuring the second stop object to appear in the scroll stop location, and rendering a set of content within a view frame of the scroll box. The set of content may include the second stop object and a subset of scroll-box content starting from the scroll stop location.

### CROSS-REFERENCE TO RELATED APPLICATION

This application is a divisional application under 35 U.S.C. § 121 of U.S. patent application Ser. No. 14/325,060, filed on Jul. 7, 2014. The Ser. No. 14/325,060 application is incorporated herein by reference in its entirety.

### FIELD

Some embodiments described herein generally relate to managing documents including scroll boxes.

### BACKGROUND

Unless otherwise indicated herein, the materials described herein are not prior art to the claims in the present application and are not admitted to be prior art by inclusion in this section.

A document such as a flyer may have limited space for presenting content. An editor of the document may be confined by the limited space in the document. For example, if the content to be added to the document exceeds the space available in the document, the editor may need to truncate the content before adding it to the document.

In addition, a client device such as a smartphone or a tablet may have limited memory space. If the client device is used to render a document, a substantial amount of memory on the client device may be dedicated to the rendering of the document. Thus, an operating speed of the client device may be slowed down.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some example embodiments described herein generally relate to techniques for managing documents that may include scroll boxes.

In an example embodiment, a method to interact with a scroll box in a document is described. The method may include receiving data indicating a navigation in a scroll box of a document. The method may also include determining a scroll offset associated with the navigation. The method may additionally include determining a scroll stop location that corresponds to the scroll offset in the scroll box. The method may additionally include determining whether the scroll stop location is associated with a first stop object in the scroll box. In response to the scroll stop location not being associated with the first stop object, the method may additionally include determining a second stop object preceding the scroll stop location in the scroll box, configuring the second stop object to appear in the scroll stop location, and rendering a set of content within a view frame of the scroll box. The set of content may include the second stop object and a subset of scroll-box content starting from the scroll stop location.

In another example embodiment, an article of manufacture including a non-transitory computer storage medium has computer instructions stored thereon that are executable by a computing device to perform operations. The operations may include receiving data indicating a navigation in a scroll box of a document. The operations may also include determining a scroll offset associated with the navigation. The operations may also include determining a scroll stop location that corresponds to the scroll offset in the scroll box. The operations may also include determining whether the scroll stop location is associated with a first stop object in the scroll box. The operations may also include, in response to the scroll stop location not being associated with the first stop object: determining a second stop object preceding the scroll stop location in the scroll box; configuring the second stop object to appear in the scroll stop location; and rendering a set of content within a view frame of the scroll box, the set of content including the second stop object and a subset of scroll-box content starting from the scroll stop location.

In another example embodiment, a method to interact with a scroll box in a document may include receiving input effective to scroll through content of a scroll box having a view frame that is smaller than the content. The method may also include selectively rendering headers associated with a plurality of sections of the content at a top of the view frame as the content of the scroll box scrolls. Selectively rendering the headers may include determining that a scroll stop location in the view frame of the scroll box is in a first section of content that includes a first header. The first section of content may be larger than the view frame such that only a portion of the first section of content is visible in the view frame at any given time when the scroll stop location is determined to be in the first section of content. The first header may be located at a top of the first section of content. Selectively rendering the headers may also include rendering the first header at the top of the view frame so long as the scroll stop location in the view frame of the scroll box is determined to be in the first section of content, including rendering the first header at the top of the view frame when the scroll stop location in the view frame is below the top of the first section of content while still being within the first section of content. Selectively rendering the headers may also include determining that the scroll stop location in the view frame of the scroll box is in a second section of content that includes a second header. The second section of content may follow the first section of content and may be larger than the view frame such that only a portion of the second section of content is visible in the view frame at any given time when the scroll stop location is determined to be in the second section of content. The second header may be located at a top of the second section of content. Selectively rendering the headers may also include rendering the second header at the top of the view frame so long as the scroll stop location in the view frame of the scroll box is determined to be in the second section of content, including rendering the second header at the top of the view frame when the scroll stop location in the view frame is below the top of the second section of content while still being within the second section of content.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an example operating environment including a server and one or more client devices configured to manage documents;

FIG. 2A shows an example flow diagram of a method of creating and managing a scroll box in a document that may be performed by a client device;

FIGS. 2B and 2C include graphic representations that illustrate aspects of an example embodiment of the method of FIG. 2A;

FIG. 3 shows an example flow diagram of a method of interacting with a scroll box in a document that may be performed by a client device;

FIG. 4 shows an example flow diagram of a method of conserving memory space for rendering a document that may be performed by a client device;

FIG. 5 shows an example flow diagram of a method of assigning items in a document to one or more render layers that may be performed by a client device;

FIGS. 6A-6F include a set of graphic representations that illustrate aspects of an example embodiment of the method of FIG. 3;

FIG. 7 includes a graphic representation that illustrates aspects of an example embodiment of the methods of FIGS. 4-5; and

FIG. 8 is a block diagram illustrating an example computing device that is arranged for managing documents.

### DETAILED DESCRIPTION OF SOME EXAMPLE EMBODIMENTS

Embodiments described herein generally relate to techniques for managing documents that may include scroll boxes. The documents may be managed in a browser-based user interface (UI), a native app on a smartphone or other mobile device, or another suitable application. For example, a browser (or app) on a client device may be used to add one or more scroll boxes to one or more document pages and to edit the one or more scroll boxes on the one or more document pages. An editing operation related to a scroll box may include, but is not limited to, adding content to the scroll box, marking one or more objects in the scroll box as stop objects, and adjusting a location and/or a size of a view frame of the scroll box. In these and other embodiments, the addition of scroll boxes on a document page may free an editor from the bounds of the document page with scrolling areas, allowing the editor to add additional content in the scrolling areas.

Some embodiments described herein may allow interacting with scroll boxes that include stop objects. For example, if a viewer scrolls down in a scroll box of a document, a scroll offset associated with the viewer's downward scrolling may be determined. A scroll stop location associated with the scroll offset may also be determined. A stop object such as a header immediately preceding the scroll stop location may be determined. The stop object may be duplicated in the scroll stop location. Alternatively, a location offset may be applied to the stop object so that the stop object may appear in the scroll stop location. As a result, the stop object (e.g., the original stop object applied with the location offset or the duplicated stop object) and a subset of scroll-box content starting from the scroll stop location may be rendered within a view frame of the scroll box. In some examples, the stop object may be rendered at the top of the view frame. In these and other examples, from the viewer's perspective, the stop object may first appear to scroll up to the top of the view frame when the viewer scrolls down in the scroll box to view scroll-box content related to the stop object. The stop object may then stop at the top of the view frame until a next stop object (e.g., a next header) scrolls up to the top of the view frame. When the next stop object reaches the top of the view frame, indicating that the viewer is viewing scroll-box content related to the next stop object, the stop object may be scrolled out of sight from the top of the view frame. The next stop object and/or a duplicate of the next stop object may replace the stop object to be rendered at the top of the view frame.

Some embodiments described herein may also allow minimizing an amount of memory used to render a document on a client device. For example, a browser (or app) on a client device may be used to obtain a document from a server. The document may include a set of items to be rendered. The browser (or app) may assign the set of items to one or more render layers so that a total render surface area of the one or more render layers may be minimized. The browser (or app) may render the document including the set of items based on the one or more render layers.

Some embodiments described herein may also allow packaging a document with a render application in a file and sending the file that includes the document and the render application for publication. The packaging of the document with the render application may provide compatibility for the document publication since different versions of the render application may be used in the publication. For example, assume the render application has been upgraded to a new version. The publication of the document may not be affected by the upgrade of the render application since the document may be packaged with the previous render application for publication.

Reference will now be made to the drawings to describe various aspects of some example embodiments of the invention. The drawings arc diagrammatic and schematic representations of such example embodiments, and are not limiting of the present invention, nor arc they necessarily drawn to scale.

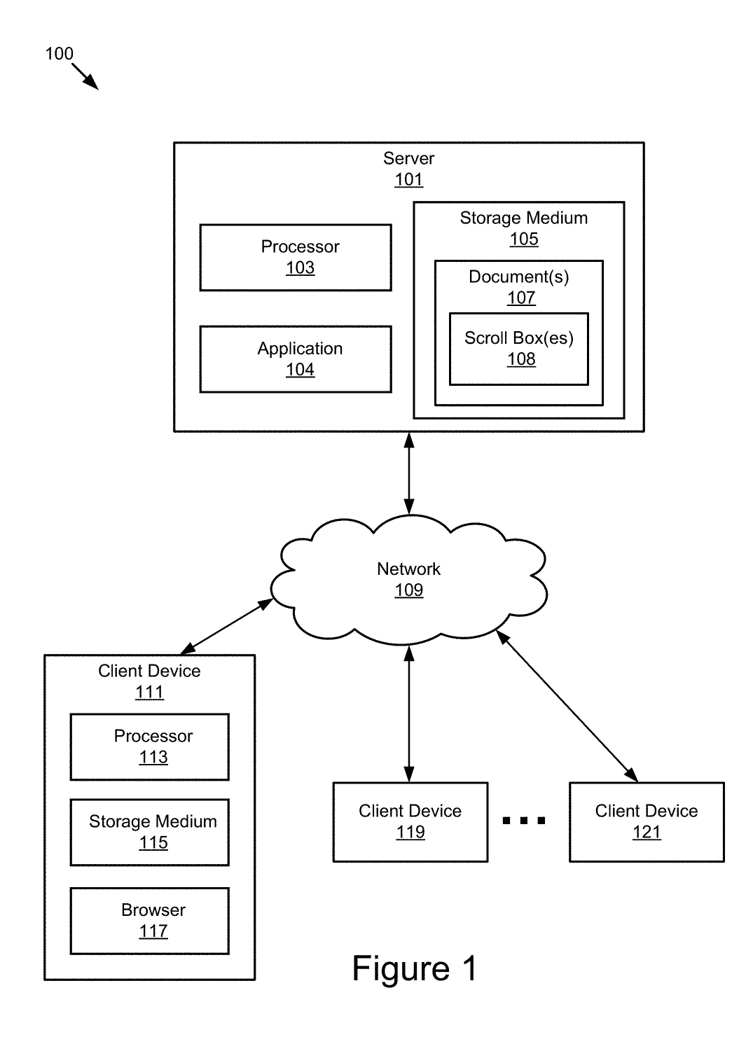

FIG. 1 is a block diagram of an example operating environment 100 including a server 101 and one or more client devices 111, 119, 121 configured to manage documents, arranged in accordance with at least some embodiments described herein. Each document may be created locally by one or more of the client devices 111, 119, 121 and/or may be stored on and accessed from the server 101. Although one server 101 and three client devices 111, 119, 121 are illustrated in FIG. 1, more generally, the operating environment 100 may include one or more servers 101 and one or more client devices 111, 119, 121. In these and other embodiments, the operating environment 100 may include other servers and/or devices not shown in FIG. 1, such as a publishing platform configured to publish documents. Example publishing platforms may include, but are not limited to, the server 101, a web server (not shown), a social network server (not shown), and other suitable publishing platforms for publishing digital documents and/or other content.

The operating environment 100 may additionally include a network 109. In general, the network 109 may include one or more wide area networks (WANs) and/or local area networks (LANs) that enable the server 101 and the client devices 111, 119, 121 to communicate with each other. In some embodiments, the network 109 may include the Internet, including a global internetwork formed by logical and physical connections between multiple WANs and/or LANs. Alternately or additionally, the network 109 may include one or more cellular radio frequency (RF) networks and/or one or more wired and/or wireless networks such as, but not limited to, 802.xx networks, Bluetooth access points, wireless access points, Internet Protocol (IP)-based networks, or the like. The network 109 may also include servers that enable one type of network to interface with another type of network.

In general, the server 101 may host a web-based publishing application (“application 104”) that allows the client devices 111, 119, 121 to create and edit documents 107 as described herein. Alternately or additionally, the server 101 may facilitate collaboration between multiple client devices 111, 119, 121 by cooperating with the client devices 111, 119, 121 to implement version control and synchronization of the documents 107.

The server 101 may additionally include a processor 103 and a storage medium 105. The processor 103 may be of any type including, but not limited to, a central processing unit (CPU), a microprocessor (μP), a microcontroller (μC), a digital signal processor (DSP), or any combination thereof. The processor 103 may be configured to execute computer instructions that, when executed, cause the processor 103 to perform one or more of the operations described herein with respect to the server 101.

The storage medium 105 may include volatile memory such as random access memory (RAM), persistent or non-volatile storage including, but not limited to, read only memory (ROM), electrically erasable and programmable ROM (EEPROM), compact disc-ROM (CD-ROM) or other optical disk storage, magnetic disk storage or other magnetic storage device, NAND flash memory or other solid state storage device, or other persistent or non-volatile computer storage medium. The storage medium 105 may store computer instructions that may be executed by the processor 103 to perform one or more of the operations described herein with respect to the server 101.

The storage medium 105 may additionally store the documents 107 created and/or published by users. In some embodiments, the documents 107 may be downloaded from the server 101 and viewed on one or more client devices 111, 119, 121. In some embodiments, the documents 107 may include print documents and digital documents. Example documents 107 may include, but arc not limited to, a flyer, a brochure, a newsletter, a magazine, a book, a photo book, and a digital document file. In these and other embodiments, the document 107 may include text, images, scrolling areas, videos, photo galleries, and/or other interactivity such as interactive sections allowing users to provide inputs. For example, the document 107 may include one or more scroll boxes 108 embedded in the document 107.

In some embodiments, the server 101 may be configured to cooperate with the client devices 111, 119, 121 to allow the client devices 111, 119, 121 to create a new document, to obtain a document from the server 101 using a corresponding browser (or app), such as a browser 117, to edit a document, to store a document in the server 101, to render a document on a display device, and to publish a document on a publishing platform.

Each of the client devices 111, 119, 121 may execute an application, such as the browser 117, configured to communicate through the network 109 with the server 101. Each of the other client devices 119, 121 may be similarly configured to execute a browser, such as the browser 117. The browser 117 may include an Internet browser or other suitable application for communicating through the network 109 with the server 101. The browser 117 may download and/or interact with content, such as websites including web pages, documents, and/or applications hosted by the server 101 or other servers (not shown) in the operating environment 100. For example, a document including one or more scroll boxes from the server 101 can be opened in the browser 117 for editing, or such a document may be created on the client device 111 in the browser 117. Each of the client devices 111, 119, 121 may include, but is not limited to, a desktop computer, a laptop computer, a tablet computer, a mobile phone, a smartphone, a personal digital assistant (PDA), or another suitable client device.

Each of the client devices 111, 119, 121 may additionally include a processor and a storage medium, such as a processor 113 and a storage medium 115 as illustrated for the client device 111 in FIG. 1. Each of the other client devices 119, 121 may be similarly configured. Similar to the processor 103 of the server 101, the processor 113 may be of any type including, but not limited to, a CPU, a μP, a μC, a DSP, or any combination thereof. The processor 113 may be configured to execute computer instructions that, when executed, cause the processor 113 to perform one or more of the operations described herein with respect to the client device 111 and/or the browser 117.

Similar to the storage medium 105 of the server 101, the storage medium 115 may include volatile memory such as RAM, persistent or non-volatile storage including, but not limited to, ROM, EEPROM, CD-ROM or other optical disk storage, magnetic disk storage or other magnetic storage device, NAND flash memory or other solid state storage device, or other persistent or non-volatile computer storage medium. The storage medium 115 may store computer instructions that may be executed by the processor 113 to perform one or more of the operations described herein with respect to the client device 111 and/or the browser 117. The storage medium 115 may additionally store, at least temporarily, a document and/or other content obtained from the server 101 and/or created locally on the client device 111.

Embodiments described herein are not limited to using a browser to create and/or manage documents. For example, rather than or in addition to a browser, the client devices 111, 119, 121 may include a native app as are often used on client devices such as mobile devices including smartphones and tablet computers. Accordingly, embodiments described herein generally include creating and/or managing documents using a browser, a native app, or another suitable application.

For convenience in the discussion that follows, the management of documents is discussed as being performed on documents obtained from the server 101 that is remote from the client devices 111, 119, 121 and by a browser such as the browser 117. It is understood, however, with the benefit of the present disclosure, that a source location of the documents may instead be local, such as the storage medium 115, and that the management of documents may be done on the client devices 111, 119, 121 by a browser, a native app, or another suitable application.

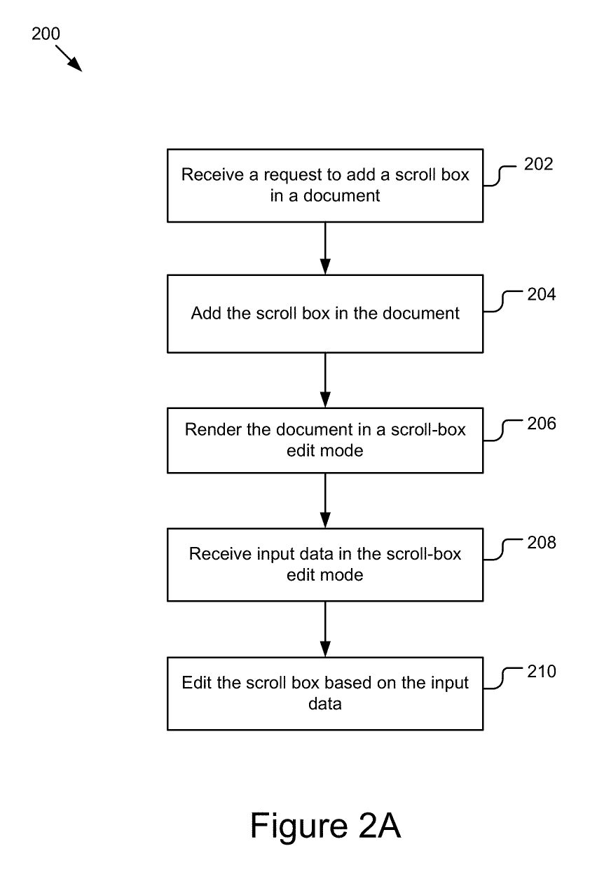

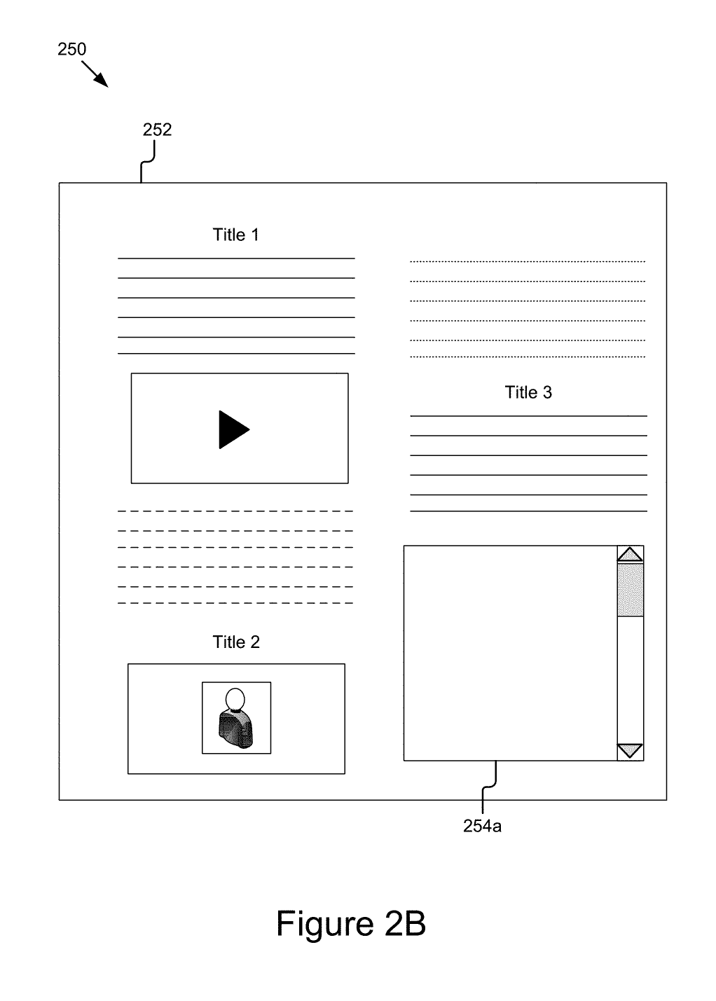

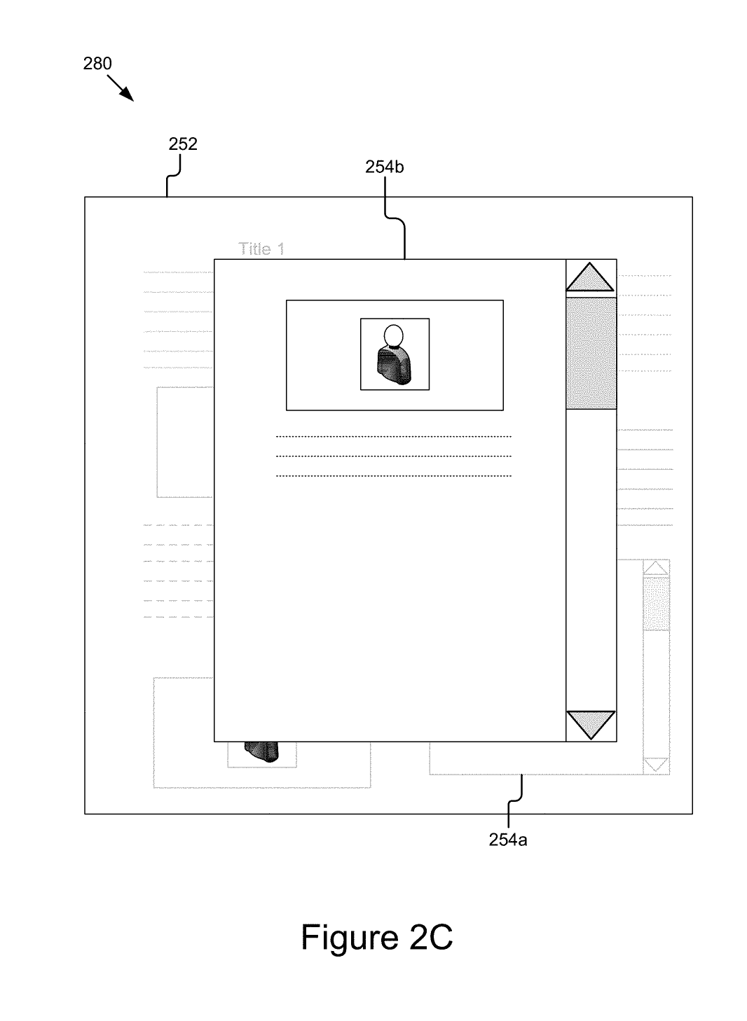

FIG. 2A shows an example flow diagram of a method 200 of creating and managing a scroll box in a document, arranged in accordance with at least some embodiments described herein. The method 200 may be performed in whole or in part by, e.g., any of the client devices 111, 119, 121 of FIG. 1. Although illustrated as discrete blocks, various blocks may be divided into additional blocks, combined into fewer blocks, or eliminated, depending on the desired implementation.

The method 200 may begin at block 202 in which a request to add a scroll box in a document is received. For example, a user (e.g., an editor or an owner of a document) may use a browser executing on a client device (e.g., the browser 117 on the client device 111) to create a new document or to open a document obtained from the server 101. The user may drag a scroll box symbol from a toolbar in the browser and may drop the scroll box symbol to a particular location in the document. Alternately or additionally, other input may be effective to request the addition of the scroll box in the document. Data describing the user's drag-and-drop operation performed on the document or other input may be received by the method 200.

In block 204, the scroll box may be added in the document. For example, responsive to receiving the request to add the scroll box, the method 200 may add a view frame with a scroll bar in a particular location of the document. In some examples, the location for the scroll box may be specified by the user. The view frame with the scroll bar may specify, for example, a scrolling area for the scroll box.

In block 206, the document including the scroll box may be rendered in a scroll-box edit mode. For example, the user may select the scroll box by clicking on the scroll box so that a scroll-box edit mode may be presented to the user. The scroll-box edit mode may be a mode allowing the user to edit the scroll box. For example, in the scroll-box edit mode, the scroll box may be rendered as an active item for the user to edit, while other content in the document may be rendered as inactive content that may be grayed out, blacked out, partially or completely obscured, or otherwise identified or indicated as inactive content. In some examples, the other content may be rendered as static content or content being faded out.

In block 208, in the scroll-box edit mode, input data for editing the scroll box may be received. In some embodiments, the input data may include, but is not limited to, content to be added to the scroll box, data for adjusting a size and/or a location of a view frame of the scroll box, data describing one or more objects to be marked as stop objects, and/or other data for editing the scroll box. The stop objects are described below in more detail.

In some embodiments, the input data may be data provided by the user. For example, the input data may describe the user's interaction with the scroll box. In a further example, the user may copy and paste content in the scroll box, move the scroll box to a new location in the document, select a check box to mark (or otherwise mark) one or more headers in the scroll box as stop objects and/or adjust the size of the view frame of the scroll box. However, in some embodiments, the size of the view frame may be static and may not be adjusted by the user.

In block 210, the scroll box may be edited based on the input data. The editing of the scroll box may include, but is not limited to, adding content to the scroll box, renaming the scroll box, modifying the font size and font face of the text in the scroll box, adjusting the location and/or size of the scroll box, and marking one or more objects in the scroll box as stop objects.

Throughout the present disclosure, content included in a scroll box may be referred to herein as scroll-box content. The scroll-box content filled in the scroll box may be part of the content of the document that includes the scroll box. In some embodiments, the scroll-box content in the scroll box may include one or more sections, where each section may include a corresponding header marked as a stop object.

An object marked as a stop object may include any object in the scroll-box content. For example, an object marked as a stop object may include a title, a subtitle, a header, a piece of text, an image, a link, a video, or other object or content present in the scroll-box content.

In some embodiments, a stop object in a scroll box may include an object in the scroll box that may be scrolled to a particular location in a view frame of the scroll box and then may reside at (or may be duplicated at) the particular location if content related to the stop object continues to be rendered in the view frame of the scroll box. While the stop object may stop scrolling and reside at (or be duplicated at) the particular location, other content related to the stop object in the scroll box may keep scrolling responsive to the user's scrolling operation in the scroll box.

For example, a first header located in the middle of the scroll-box content may be a stop object. A second header located after the first header in the scroll-box content may also be a stop object. Initially, the first header may not be rendered in the view frame of the scroll box. If the user scrolls down in the scroll box, the first header may be scrolled up and may be rendered at the top of the view frame when the user is viewing scroll-box content related to the first header. Even though the user may continue scrolling up or down when viewing the scroll-box content related to the first header, the first header may appear to stop scrolling and may reside at the top of the view frame. If the user keeps scrolling down, the second header may be scrolled up to the top of the view frame, indicating the user is viewing scroll-box content related to the second header. The second header may then replace the first header to be rendered at the top of the view frame. However, if the user scrolls up to view content related to the first header again, the second header may be scrolled out of sight from the top of the view frame and the first header may be rendered at the top of the view frame again.

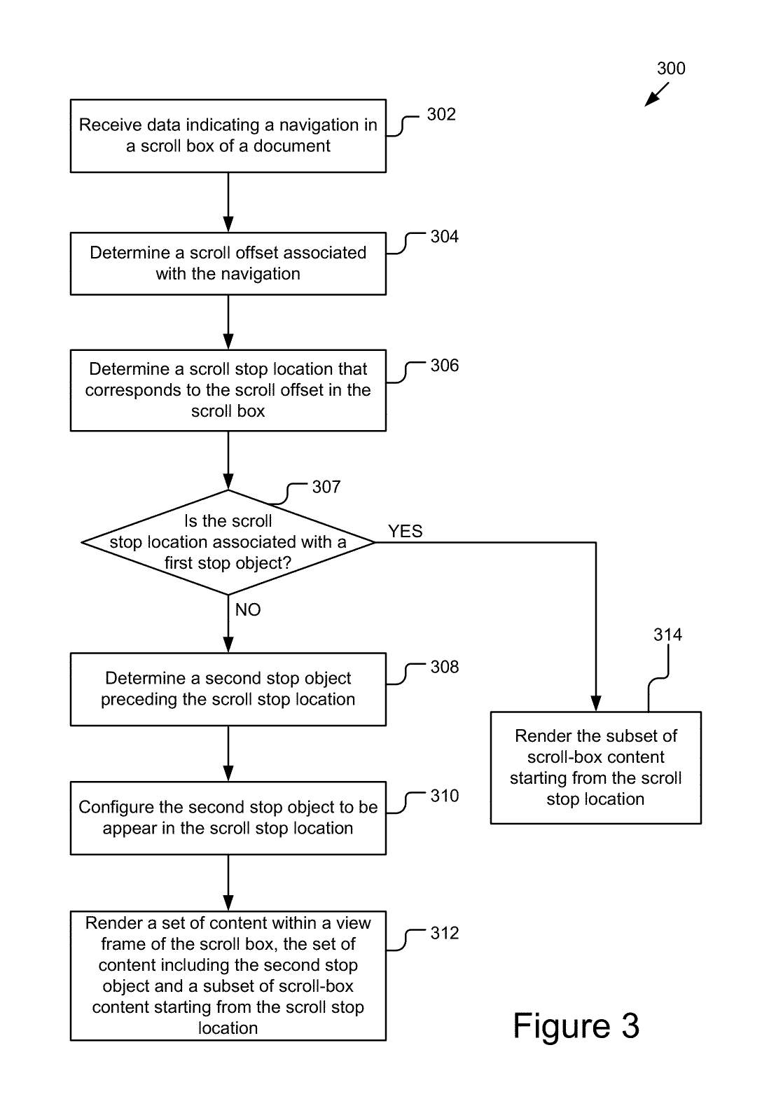

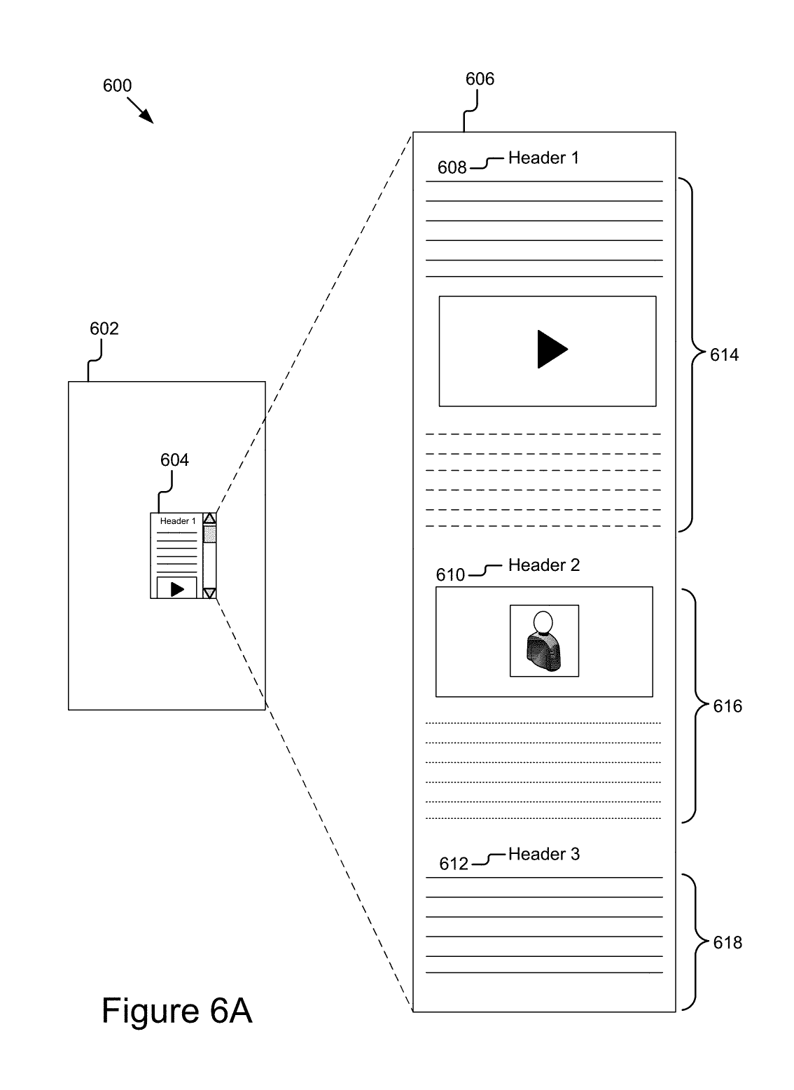

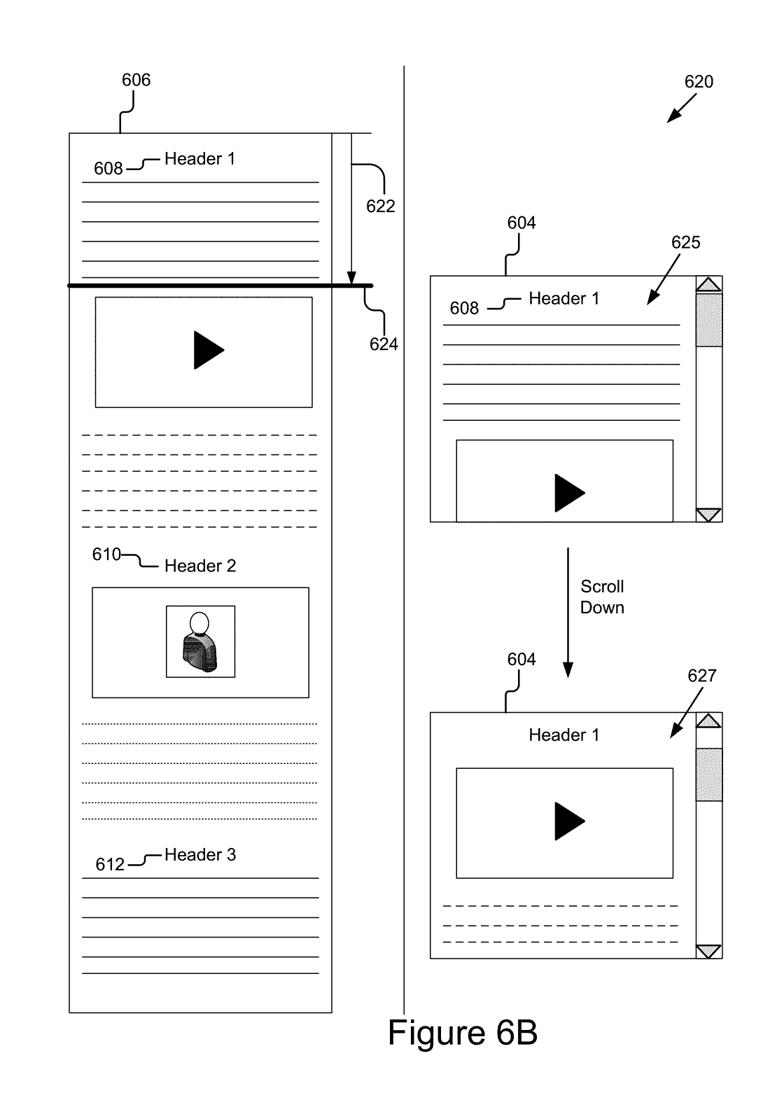

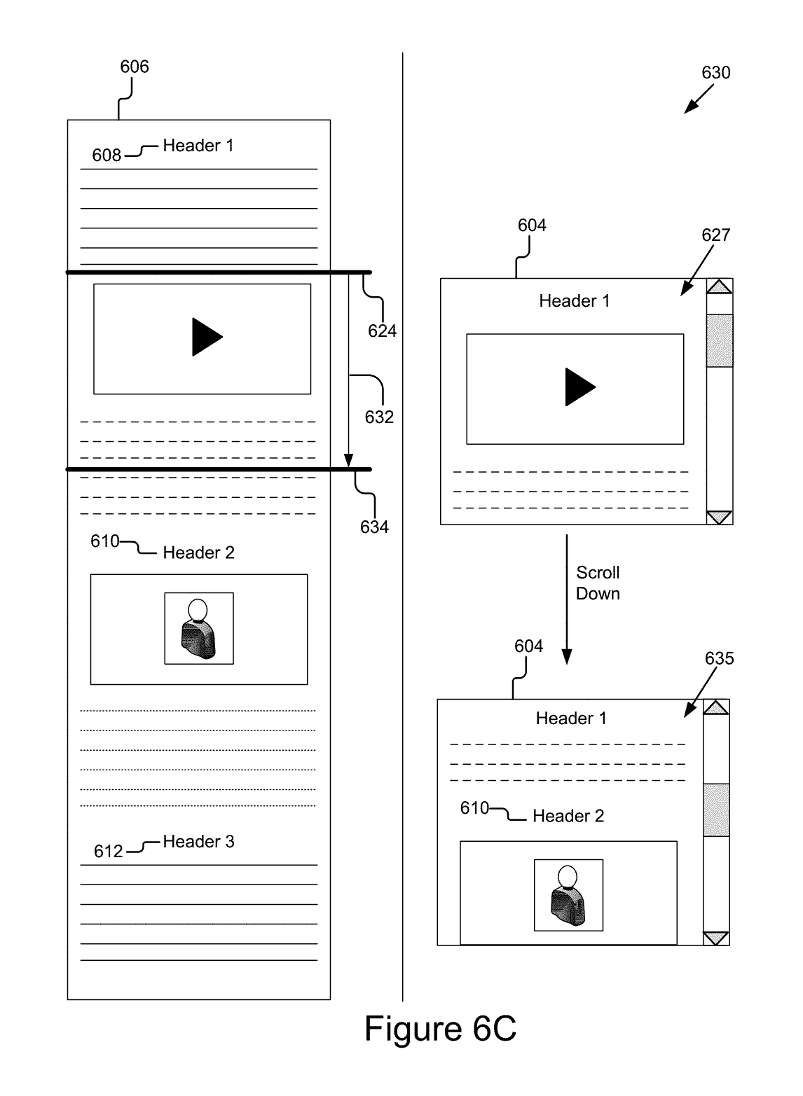

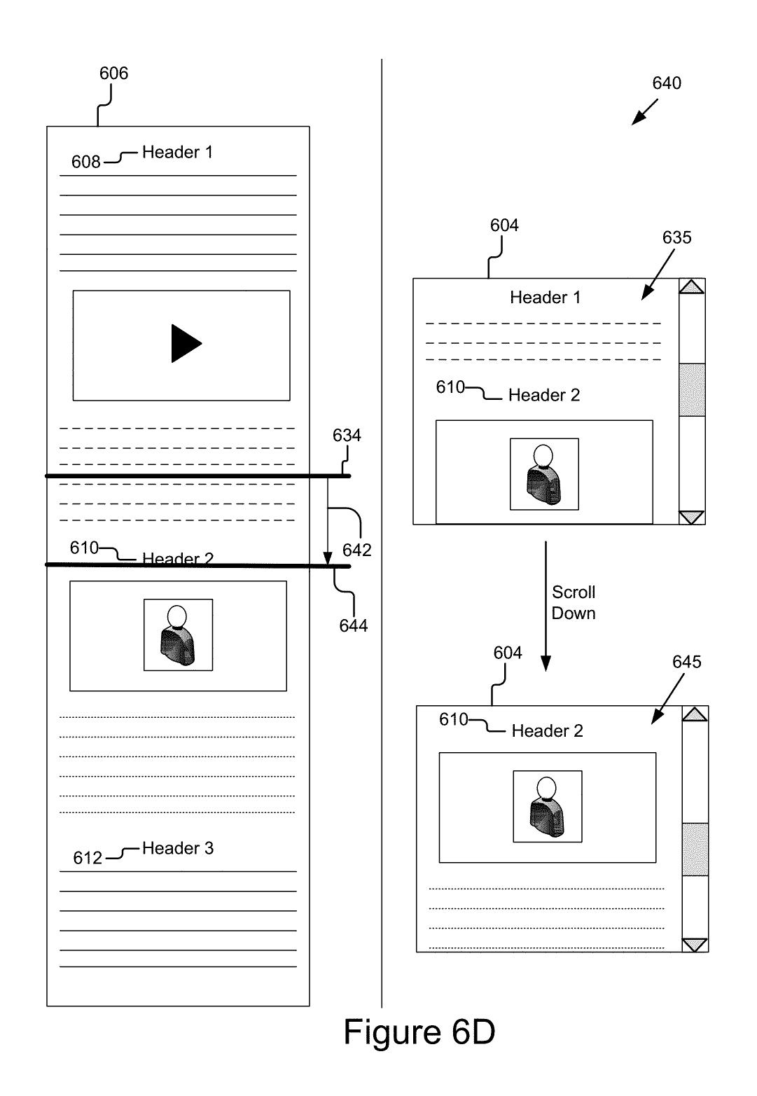

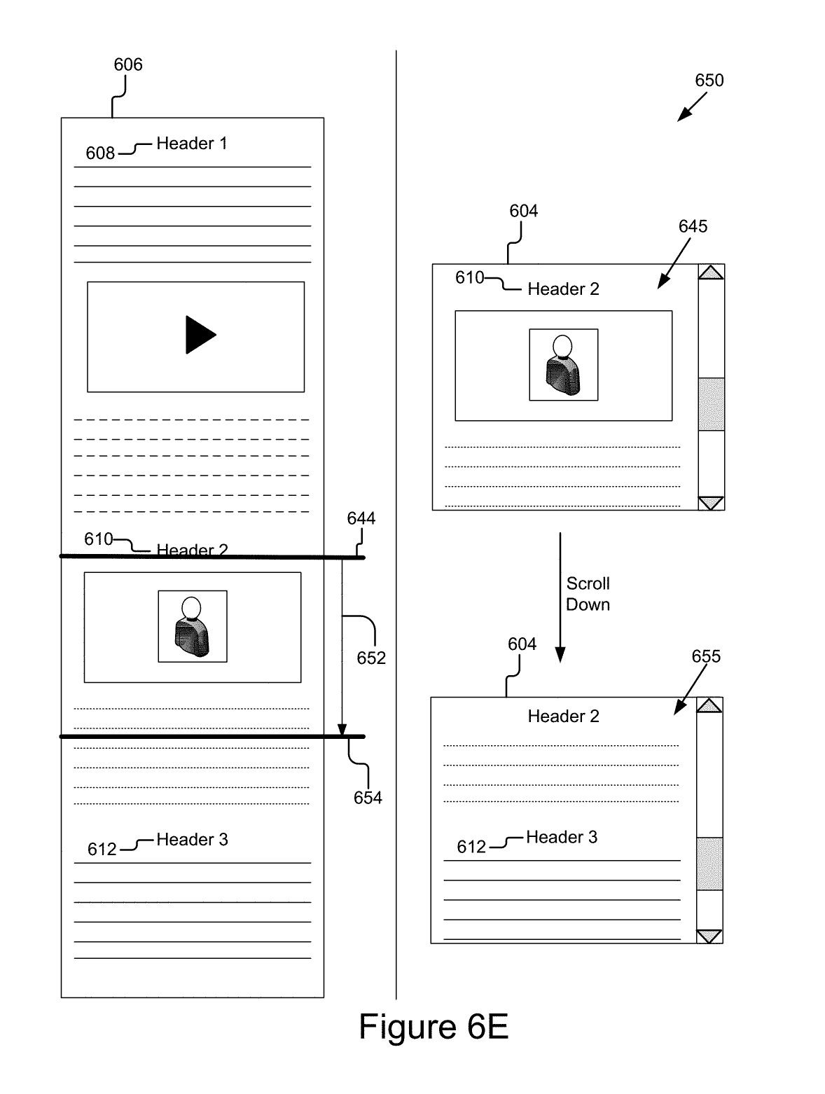

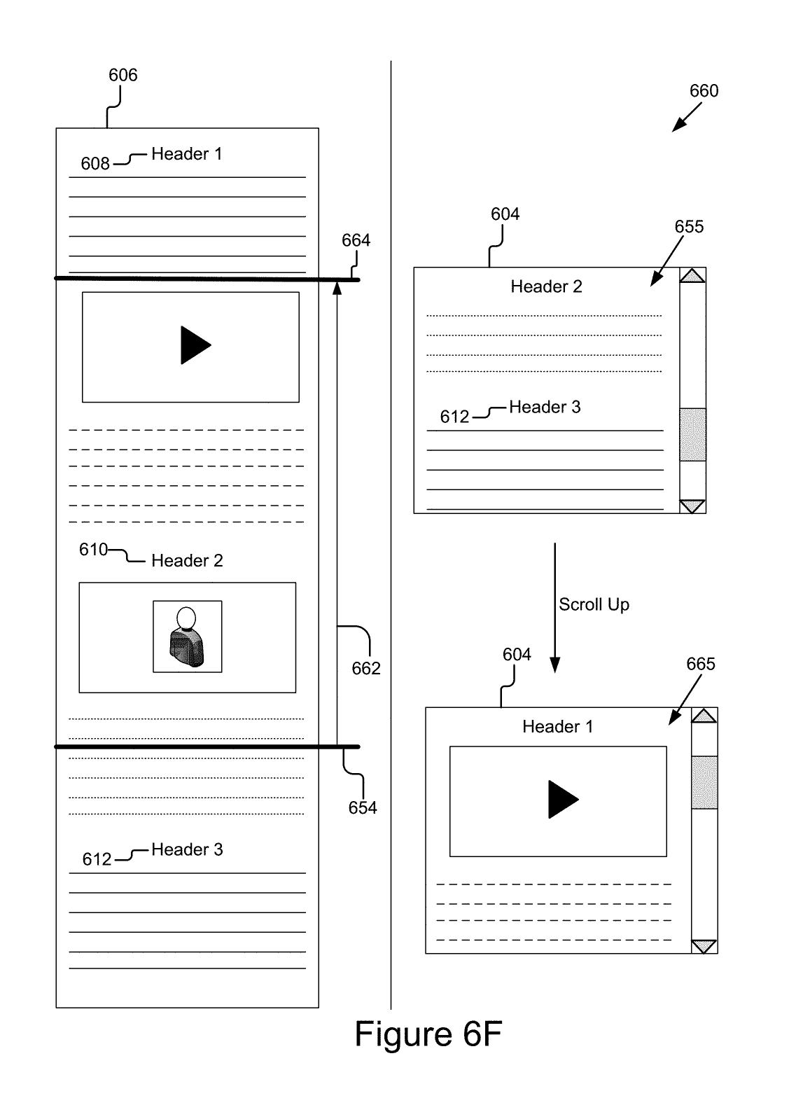

Example stop objects may include, but are not limited to, a title, a subtitle, a header, a piece of text, an image, a video, or other content in the scroll-box content. Further example implementations of stop objects in documents are described below in more detail with reference to FIGS. 3 and 6A-6F.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, in some embodiments, the method 200 may further include providing a preview of the document to the user, such as the editor. The preview of the document may illustrate a relation of the view frame of the scroll box to other document content. The preview of the document may also provide a viewing simulation to the editor that illustrates how the scroll-box content may be viewed by viewers.

In some embodiments, the method 200 may additionally include publishing the document on a publishing platform. For example, the client device performing the method 200 may package the document with a render application in a file, where the render application may include code configured to render the document on the publishing platform. The client device may send the file including the document and the render application to the publishing platform, causing the publishing platform to publish the document using the render application. The file packaged with the document and the render application may include text, metadata, images, videos, Hypertext Markup Languages (HTMLs), Cascading Style Sheets (CSS), and JavaScript. Packaging the document with the render application may avoid publication incompatibility in the future since the document can be published using the render application in the packaged file at any time.

Some embodiments disclosed herein include an article of manufacture such as a non-transitory computer storage medium having instructions stored thereon that are executable by a computing device to perform operations included in the method 200 of FIG. 2A, such as the operations illustrated by blocks 202, 204, 206, 208, and/or 210 in FIG. 2A, and/or variations thereof. The non-transitory computer storage medium may be included in or may be accessible to one or more of the client devices 111, 119, 121 of FIG. 1. The computing device may include any of the client devices 111, 119, 121, and/or a processor or other processing device of the client devices 111, 119, 121, such as the processor 113.

As mentioned previously, embodiments described herein are not limited to using a browser to create and edit documents with scroll boxes. For example, a variant of the method 200 of FIG. 2A may include pulling a document from the server 101 into an application (such as a browser or a native app) executing on a client device; editing the document to add one or more scroll boxes to the document using the application; and publishing the document from the application to a publishing platform accessible to the client device.

FIGS. 2B and 2C include graphic representations 250 and 280 that illustrate aspects of an example embodiment of the method of FIG. 2A, arranged in accordance with at least some embodiments described herein. With combined reference to FIGS. 1-2C, an example embodiment of the method 200 will now be described.

Referring to FIG. 2B, a scroll box 254a is added to a document 252 responsive to a request received from a user. The user may select to edit the scroll box 254a, causing the document 252 to be rendered in a scroll-box edit mode as illustrated in FIG. 2C.

Referring to FIG. 2C, content in the document 252 is grayed out in the scroll-box edit mode. The scroll box 254a is presented as an active item 254b in the scroll-box edit mode, allowing the user to add content to the scroll box 254a by adding content to the active item 254b.

FIG. 3 shows an example flow diagram of a method 300 of interacting with a scroll box in a document, arranged in accordance with at least some embodiments described herein. The method 300 may be performed in whole or in part by, e.g., any of the client devices 111, 119, 121 of FIG. 1. Although illustrated as discrete blocks, various blocks may be divided into additional blocks, combined into fewer blocks, or eliminated, depending on the desired implementation.

The method 300 may begin at block 302 in which data indicating a navigation in a scroll box of a document may be received. In some embodiments, the navigation in the scroll box may be one of a downward scrolling in the scroll box, an upward scrolling in the scroll box, and a combination thereof. For example, a user (e.g., a viewer of a document) may use a browser executing on a client device to open a document obtained from the server 101. The user may scroll up or scroll down in a scroll box of the document using a pointing device such as a mouse, a stylus, or finger, or using keyboard inputs (e.g., up and down arrows, space bar, or other keyboard inputs).

In block 304, a scroll offset associated with the navigation may be determined. The scroll offset may describe a scrolling distance in the scroll-box content caused by the navigation. For example, the scroll offset may describe a distance that the user scrolls down in the scroll box in a downward scrolling. In another example, the scroll offset may describe a distance that the user scrolls up in the scroll box in an upward scrolling. In some embodiments, the scroll offset may describe a distance between a previous scroll stop location and a current scroll stop location, or between a top or bottom of the scroll box (or other reference location) and the current scroll stop location.

In block 306, a scroll stop location that corresponds to the scroll offset in the scroll box may be determined. A scroll stop location may include a location in the scroll-box content where the navigation stops. For example, a scroll stop location may include a location in the scroll-box content where a downward scrolling or an upward scrolling in the scroll box stops, such as a topmost line (or a bottommost line, or other selected line) of the scroll-box content that is viewable in the view frame of the scroll box.

In block 307, the method 300 may include determining whether the scroll stop location is associated with a first stop object. For example, the method 300 may determine whether a first stop object such as a header is present in the scroll stop location in the scroll-box content. If the scroll stop location is associated with the first stop object (e.g., the first stop object is present in the scroll stop location), there may be no need to insert another stop object at the scroll stop location, and the method 300 may proceed to block 314. Otherwise, the method 300 may proceed to block 308.

At block 308, if the scroll stop location is not associated with the first stop object, a second stop object preceding the scroll stop location may be determined. For example, if there arc no stop objects present in the scroll stop location, a stop object such as a header immediately preceding the scroll stop location may be determined.

In block 310, the second stop object may be configured to appear in the scroll stop location. In some embodiments, a duplicate of the second stop object may be inserted in the scroll stop location. For example, the header immediately preceding the scroll stop location may be duplicated in the scroll stop location of the scroll-box content. Alternatively, a location offset may be applied to the original second stop object so that the original second stop object may appear in the scroll stop location. For example, a location offset may be applied to the preceding header so that the header may appear in the scroll stop location of the scroll-box content. In some embodiments, if the second stop object (e.g., the original second stop object applied with the location offset or the duplicate of the second stop object) in the scroll stop location overlaps with a third stop object located below the scroll stop location, the second stop object may be pushed up so that the second stop object and the third stop object may not overlap with each other.

In block 312, a set of content may be rendered within the view frame of the scroll box, where the set of content may include the second stop object in the scroll stop location and a subset of scroll-box content starting from the scroll stop location. For example, the second stop object (e.g., the original second stop object applied with the location offset or the duplicate of the second stop object) may be rendered at the top of the view frame, followed by the rendering of the subset of scroll-box content starting from the scroll stop location.

At block 314, if the scroll stop location is associated with the first stop object (e.g., the first stop object is present in the scroll stop location), the subset of scroll-box content starting from the scroll stop location may be rendered. For example, the subset of scroll-box content may include the first stop object present in the scroll stop location, where the first stop object may be rendered at the top of the view frame, followed by the rendering of other scroll-box content starting from the scroll stop location.

An example use of the method 300 will now be described. For example, assume initially a first part of the scroll-box content is presented to a user, with a first header displayed at the top of the view frame of the scroll box. If the user scrolls down 40 pixels in the scroll box, a first scroll offset may be determined as 40 pixels down from the first header. A first scroll stop location may be determined as a location in the scroll-box content which is 40 pixels down from the first header. Next, the method 300 may determine that no header is present in the first scroll stop location and that a header immediately preceding the first scroll stop location is the first header. A duplicate of the first header may be inserted in the first scroll stop location. Alternatively, an offset may be applied to the first header so that the first header may appear in the first scroll stop location. Thus, the first header may be rendered at the top of the view frame of the scroll box, followed by the rendering of a subset of scroll-box content starting from the first scroll stop location within the view frame. If the user continues to scroll down another 30 pixels in the scroll box, a second scroll offset may be determined as 30 pixels down from the first scroll stop location. A second scroll stop location may be determined as a location which is 70 pixels (e.g., 40 pixels+30 pixels=70 pixels) down from the first header. If there is already a second header present in the second scroll stop location, a subset of scroll-box content including the second header may be rendered within the view frame of the scroll box, where the second header may be rendered at the top of the view frame.

Some embodiments disclosed herein include an article of manufacture such as a non-transitory computer storage medium having instructions stored thereon that are executable by a computing device to perform operations included in the method 300 of FIG. 3, such as the operations illustrated by blocks 302, 304, 306, 307, 308, 310, 312, and/or 314 in FIG. 3, and/or variations thereof. The non-transitory computer storage medium may be included in or may be accessible to one or more of the client devices 111, 119, 121 of FIG. 1. The computing device may include any of the client devices 111, 119, and/or a processor or other processing device of the client devices 111, 119, 121, such as the processor 113.

As mentioned previously, embodiments described herein are not limited to using a browser to interact with documents that include scroll boxes. For example, a variant of the method 300 of FIG. 3 may include pulling a document from the server 101 into an application (such as a browser or a native app) executing on a client device; interacting with a scroll box in the document within the application; and rendering scroll-box content within the view frame of the scroll box using the application.

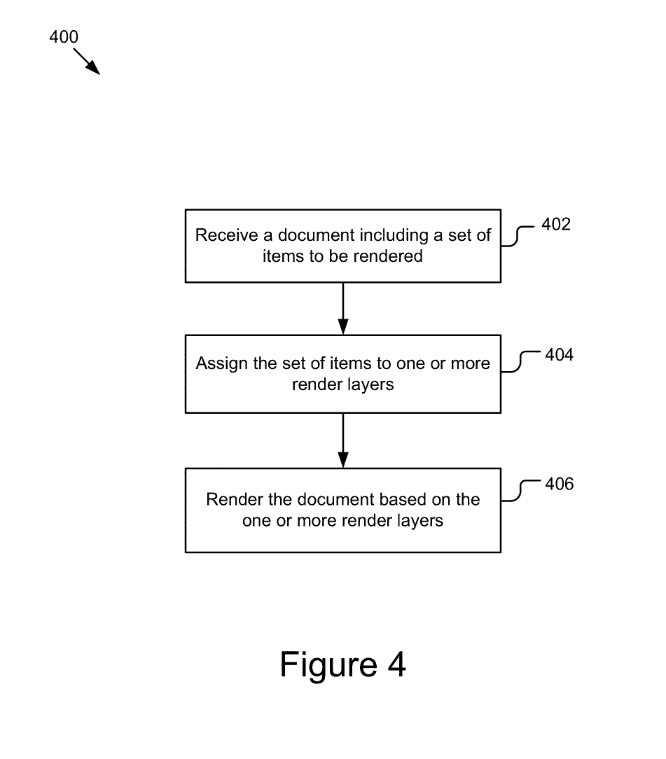

FIG. 4 shows an example flow diagram of a method 400 of conserving memory space for rendering a document, arranged in accordance with at least some embodiments described herein. The method 400 may be performed in whole or in part by, e.g., any of the client devices 111, 119, 121 of FIG. 1. Although illustrated as discrete blocks, various blocks may be divided into additional blocks, combined into fewer blocks, or eliminated, depending on the desired implementation.

The method 400 may begin at block 402 in which a document including a set of items to be rendered may be received. For example, a browser or an application on a client device performing the method 400 may receive the document including the set of items to be rendered from the server 101. The set of items may include one or more of an object added to the document by an editor of the document, a layer of objects configured by the editor, and a group of objects grouped by the editor.

In some embodiments, each item in the set of items may be classified as an interactive item or a non-interactive item. An interactive item may be an item that a user can interact with. For example, in response to an interactive input provided by a user, an interactive item may be rendered on a display device coupled to a client device associated with the user. In a further example, if the user selects a link or a button associated with the interactive item in the document, the interactive item may be rendered on the display device; however, if the user does not select the link or button associated with the interactive item, the interactive item may not be rendered on the display device. In contrast, the rendering of a non-interactive item may not require interactive inputs from the user. For example, the non-interactive items in the document may be rendered to the user when the user opens the document; however, depending on the interactive inputs provided by the user, some interactive items in the document may be rendered to the user while some other interactive items may not be rendered to the user.

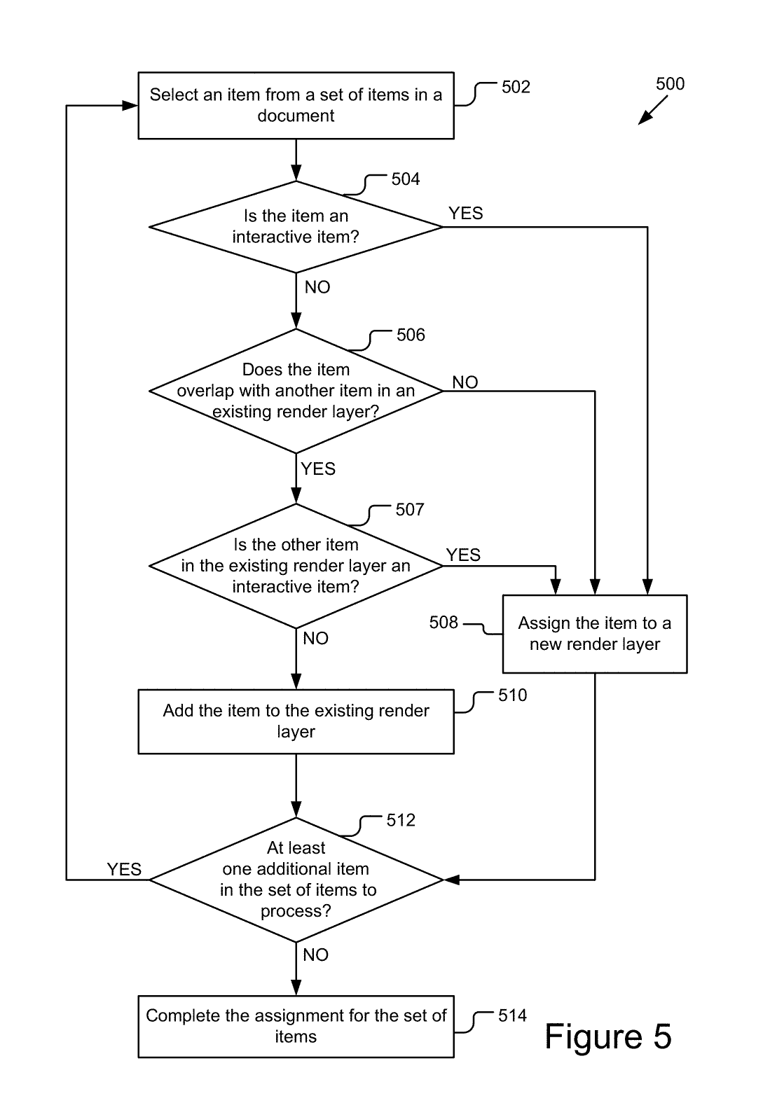

In block 404, the set of items in the document may be assigned to one or more render layers. A render layer may be a layer including one or more items that can be rendered at the same time. An example method 500 of assigning the set of items to one or more render layers is described below with reference to FIG. 5.

In some embodiments, the set of items may include one or more interactive items and/or one or more non-interactive items. Each interactive item may be assigned to a different render layer. For each non-interactive item, if the corresponding non-interactive item docs not overlap with other non-interactive items, the corresponding non-interactive item may be assigned to a separate render layer. However, if a first non-interactive item overlaps with a second non-interactive item, both the first and second non-interactive items may be assigned to the same render layer. If there is also a third non-interactive item overlapping with either the first non-interactive item or the second non-interactive item, the third non-interactive item may also be assigned to the same render layer as the first and second non-interactive items.

In some embodiments, the client device (e.g., a smartphone, a tablet) used to render the document may have limited memory space. The assignment of the overlapping non-interactive items to a common render layer may minimize the total surface area or the total footprint of content to be rendered on the client device. Thus, the amount of memory used to render the render layers on the client device may be minimized. For example, if two overlapping non-interactive items are assigned to two different render layers respectively, the overlapped portion of the two non-interactive items may be stored in two different memory locations and rendered twice, respectively. However, if the two non-interactive items are assigned to the same render layer, the overlapped portion of the two non-interactive items may be stored in one memory location and may be rendered once.

In block 406, the document may be rendered based on the one or more render layers. For example, when the document is opened, the render layers with non-interactive items may be rendered on a display device coupled to the client device. Depending on interactive inputs provided by the user viewing the document, the render layers with interactive items may or may not be rendered on the display device.

Some embodiments disclosed herein include an article of manufacture such as a non-transitory computer storage medium having instructions stored thereon that are executable by a computing device to perform operations included in the method 400 of FIG. 4, such as the operations illustrated by blocks 402, 404, and/or 406 in FIG. 4, and/or variations thereof. The non-transitory computer storage medium may be included in or may be accessible to one or more of the client devices 111, 119, 121 of FIG. 1. The computing device may include any of the client devices 111, 119, 121, and/or a processor or other processing device of the client devices 111, 119, 121, such as the processor 113.

As mentioned previously, embodiments described herein are not limited to using a browser to render documents. For example, a variant of the method 400 of FIG. 4 may include pulling the document from the server 101 into an application (such as a browser or a native app) executing on a client device; assigning the set of items in the document to one or more render layers using the application; and rendering the document based on the one or more render layers using the application.

FIG. 5 shows an example flow diagram of the method 500 of assigning a set of items in a document to one or more render layers, arranged in accordance with at least some embodiments described herein. The method 500 may be performed in whole or in part by, e.g., any of the client devices 111, 119, 121 of FIG. 1. Although illustrated as discrete blocks, various blocks may be divided into additional blocks, combined into fewer blocks, or eliminated, depending on the desired implementation. The method 500 may be part of the method 400. For example, the method 500 of FIG. 5 may correspond to or be included in block 404 of FIG. 4.

The method 500 may begin at block 502 in which an item from a set of items in a document to be rendered may be selected. For example, a browser or an application on a client device performing the method 500 may select an item in the document to process.

In block 504, the method 500 may include determining whether the item is an interactive item. If the item is an interactive item, the method 500 may proceed to block 508. Otherwise, the method 500 may proceed to block 506.

In block 506, if the item is not an interactive item (e.g., the item is a non-interactive item), the method 500 may include determining whether the item overlaps with another item in an existing render layer. If the item overlaps with another item in an existing render layer, the method 500 may proceed to block 507. Otherwise, the method 500 may proceed to block 508.

In block 507, if the item is a non-interactive item and overlaps with another item in an existing render layer, the method 500 may include determining whether the other item in the existing render layer is an interactive item. If the other item is an interactive item, the method 500 may proceed to block 508. Otherwise, the method 500 may proceed to block 510.

In block 508, the item may be assigned to a new render layer. For example, if the item is an interactive item, the item may be assigned to a new render layer. In another example, if the item is a non-interactive item and docs not overlap with any other items in existing render layers, the item may be assigned to a new render layer. In yet another example, even if the item is a non-interactive item and overlaps with another item in an existing render layer, the item may be assigned to a new render layer if the other item is an interactive item.

In block 510, the item may be added to the existing render layer. For example, if the item is a non-interactive item and overlaps with another non-interactive item in an existing render layer, the item may be added to the existing render layer so that the item and the other non-interactive item may be assigned to the same render layer.

In block 512, the method 500 may include determining whether there is at least one additional item in the set of items to process. If there is at least one additional item to process, the method 500 may proceed to block 502 to select another item to process. Otherwise, the method 500 may proceed to block 514.

In block 514, the method 500 may include determining that the assignment for the set of the items is completed. For example, if all the items in the set of items arc already assigned to one or more render layers, the assignment for the set of items completes.

Some embodiments disclosed herein include an article of manufacture such as a non-transitory computer storage medium having instructions stored thereon that are executable by a computing device to perform operations included in the method 500 of FIG. 5, such as the operations illustrated by blocks 502, 504, 506, 507, 508, 510, 512, and/or 514 in FIG. 5, and/or variations thereof. The non-transitory computer storage medium may be included in or may be accessible to one or more of the client devices 111, 119, 121 of FIG. 1. The computing device may include any of the client devices 111, 119, 121, and/or a processor or other processing device of the client devices 111, 119, 121, such as the processor 113.

FIGS. 6A-6F include a set of graphic representations 600, 620, 630, 640, 650, and 660 that illustrate aspects of an example embodiment of the method of FIG. 3, arranged in accordance with at least some embodiments described herein. With combined reference to FIGS. 1, 3, and 6A-6F, an example embodiment of the method 300 will now be described.

Referring to FIG. 6A, a document 602 may be obtained from the server 101 of FIG. 1 and opened using a browser or an application on a client device under the direction of a user. For example, the document 602 may be opened using the browser 117 on the client device 111 operated by the user. In the illustrated embodiment, the document 602 includes a scroll box 604, with all the scroll-box content filled in the scroll box 604 being illustrated in a box 606. Initially, a first portion of the scroll-box content may be rendered within a view frame of the scroll box 604.

The size of a subset of scroll-box content to be rendered within the view frame of the scroll box 604 may be determined based at least in part on the size of the view frame such as a width and a height of the view frame. For simplicity and illustration purposes only, in these and other examples, the scroll-box content in the box 606 may have the same width as the view frame of the scroll box 604, and the size of the subset of the scroll-box content to be rendered within the view frame may be determined based at least in part on the height of the view frame of the scroll box 604.

The scroll-box content illustrated in the box 606 may include three sections, with each section including a corresponding header and corresponding section content. For example, a first section may include a header 608 (e.g., Header 1) and section content 614, a second section may include a header 610 (e.g., Header 2) and section content 616, and a third section may include a header 612 (e.g., Header 3) and section content 618. The headers 608, 610, and 612 may be marked as stop objects by an editor of the document.

With combined reference to FIGS. 6B-6F, the left part of each of FIGS. 6B-6E illustrates the scroll-box content in the box 606. The right part of each of FIGS. 6B-6E illustrates a corresponding rendering transition in the view frame of the scroll box 604, caused by a scrolling operation performed by the user. For example, as the user scrolls down or up in the scroll box 604, content rendered within the view frame of the scroll box 604 may be changed from a first graphic representation to a second graphic representation as illustrated in the right part of FIGS. 6B-6E.

Referring now to FIG. 6B, initially a first portion of the scroll-box content may be rendered in the view frame of the scroll box 604, as illustrated by a graphic representation 625 in the view frame of the scroll box 604. If the user scrolls down in the scroll box 604 with a scroll offset 622 as illustrated in the scroll-box content in the box 606, a scroll stop location 624 in the scroll-box content may be determined. Since there are no stop objects present in the scroll stop location 624, a stop object immediately preceding the scroll stop location 624 may be determined as the header 608 (e.g., Header 1).

Thus, the header 608 may be configured to appear in the scroll stop location 624. For example, a duplicate of the header 608 (e.g., a duplicated Header 1) may be inserted in the scroll stop location 624. In another example, a location offset may be applied to the header 608 so that the header 608 may appear in the scroll stop location 624. A set of content that includes the header 608 (e.g., the duplicated Header 1 or the header 608 applied with the location offset) and a subset of scroll-box content starting from the scroll stop location 624 may be rendered in the view frame of the scroll box 604, as illustrated in a graphic representation 627 in FIG. 6B. The size of the subset of scroll-box content starting from the scroll stop location 624 to be rendered in the view frame of the scroll box 604 may be determined based on the size of the view frame.

In these and other examples, as the user scrolls down in the scroll box 604 with the scroll offset 622 and stops scrolling at the scroll stop location 624, the content rendered in the view frame of the scroll box 604 may be changed from the graphic representation 625 to the graphic representation 627. However, Header 1 may be rendered at the top of the view frame in both of the graphic representations 625 and 627, since the user is viewing content under Header 1.

Referring to FIG. 6C, if the user continues to scroll down in the scroll box 604 with a scroll offset 632 from the previous scroll stop location 624, a scroll stop location 634 in the scroll-box content may be determined. Since there are no stop objects present in the scroll stop location 634, a stop object immediately preceding the scroll stop location 634 may be determined as the header 608 (e.g., Header 1). Thus, the header 608 may be configured to appear in the scroll stop location 634. For example, a duplicate of the header 608 (e.g., a duplicated Header 1) may be inserted in the scroll stop location 634. In another example, a location offset may be applied to the header 608 so that the header 608 may appear in the scroll stop location 634. A set of content that includes the header 608 and a subset of scroll-box content starting from the scroll stop location 634 may be rendered in the view frame of the scroll box 604, as illustrated in a graphic representation 635 in FIG. 6C.

In these and other examples, as the user scrolls down in the scroll box 604 from the previous scroll stop location 624 to the current scroll stop location 634, the content rendered in the view frame of the scroll box 604 may be changed from the graphic representation 627 to the graphic representation 635. However, Header 1 (or the duplicate thereof) may still be rendered at the top of the view frame in both of the graphic representations 627 and 635, since the user is viewing content under Header 1.

Referring to FIG. 6D, if the user continues to scroll down in the scroll box 604 with a scroll offset 642 from the previous scroll stop location 634, a scroll stop location 644 in the scroll-box content may be determined. Since the header 610 (e.g., Header 2) is marked as a stop object and is present in the scroll stop location 644, no other stop objects may be needed to insert in the scroll stop location 644. A subset of scroll-box content starting from the scroll stop location 644 may be rendered in the view frame of the scroll box 604, as illustrated in a graphic representation 645 in FIG. 6D. The subset of scroll-box content starting from the scroll stop location 644 may include the header 610 (e.g., Header 2), and the header 610 may be rendered at the top of the view frame of the scroll box 604, as illustrated in the graphic representation 645.

In these and other examples, as the user scrolls down in the scroll box 604 from the previous scroll stop location 634 to the current scroll stop location 644, the content rendered in the view frame of the scroll box 604 may be changed from the graphic representation 635 to the graphic representation 645, where the header 610 (e.g. Header 2) may replace Header 1 to be rendered at the top of the view frame.

With combined reference to the graphic representations 625, 627, 635, and 645 in FIGS. 6B-6D, from a viewer's perspective, the header 608 (e.g., Header 1) may reside at the top of the view frame when the viewer is viewing content under the header 608. The header 608 may be replaced by the header 610 (e.g., Header 2) when the header 610 scrolls up to the top of the view frame, indicating the viewer is viewing content under the header 610.

Referring to FIG. 6E, if the user continues to scroll down in the scroll box 604 with a scroll offset 652 from the previous scroll stop location 644, a scroll stop location 654 in the scroll-box content may be determined. Since there are no stop objects present in the scroll stop location 654, a stop object immediately preceding the scroll stop location 654 may be determined as the header 610 (e.g., Header 2). Thus, the header 610 may be configured to appear in the scroll stop location 654. For example, a duplicate of the header 610 (e.g., a duplicated Header 2) may be inserted in the scroll stop location 654. In another example, a location offset may be applied to the header 610 so that the header 610 may appear in the scroll stop location 654. A set of content that includes the header 610 and a subset of scroll-box content starting from the scroll stop location 654 may be rendered in the view frame of the scroll box 604, as illustrated in a graphic representation 655 in FIG. 6E.

In these and other examples, as the user scrolls down from the previous scroll stop location 644 to the current scroll stop location 654, the content rendered in the view frame of the scroll box 604 may be changed from the graphic representation 645 to the graphic representation 655. However, Header 2 may be rendered at the top of the view frame in both of the graphic representations 645 and 655, since the user is viewing content under Header 2.

With combined reference to the graphic representations 635, 645, and 655 in FIGS. 6D-6E, from a viewer's perspective, the header 610 (e.g., Header 2) may scroll up to the top of the view frame and then reside at the top of the view frame.

Referring to FIG. 6F, if the user scrolls up in the scroll box 604 with a scroll offset 662 from the previous scroll stop location 654, a scroll stop location 664 in the scroll-box content may be determined. Since there are no stop objects present in the scroll stop location 664, a stop object immediately preceding the scroll stop location 664 may be determined as the header 608 (e.g., Header 1). Thus, the header 608 may be configured to appear in the scroll stop location 664. For example, a duplicate of the header 608 (e.g., a duplicated Header 1) may be inserted in the scroll stop location 664. In another example, a location offset may be applied to the header 608 so that the header 608 may appear in the scroll stop location 664. A set of content that includes the header 608 and a subset of scroll-box content starting from the scroll stop location 664 may be rendered in the view frame of the scroll box 604, as illustrated in a graphic representation 665 in FIG. 6F.

In these and other examples, as the user scrolls up from the previous scroll stop location 654 to the current scroll stop location 664, the content rendered in the view frame of the scroll box 604 may be changed from the graphic representation 655 to the graphic representation 665. The header 608 (e.g., Header 1) may be rendered at the top of the view frame, since the user is again viewing content under Header 1.

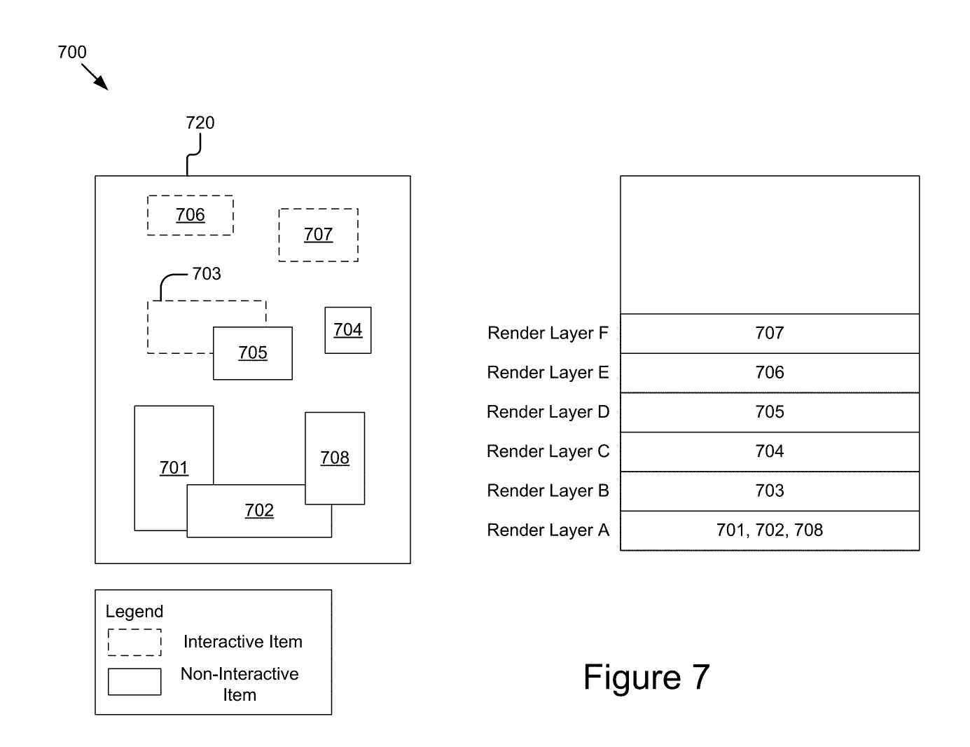

FIG. 7 includes a graphic representation 700 that illustrates aspects of an example embodiment of the methods of FIGS. 4-5, arranged in accordance with at least some embodiments described herein. With combined reference to FIGS. 1, 4-5, and 7, an example embodiment of the methods 400 and 500 will now be described. In the example embodiment, a document 720 may be obtained from the server 101 by a browser or a native app on a client device operated by a user. For example, the document 720 may be received from the server 101 by the browser 117 installed on the client device 111. The document 720 may include a set of items 701-708, where the items 701, 702, 704, 705, and 708 are non-interactive items, and the items 703, 706, and 707 are interactive items.

Initially, a first item such as the item 701 may be processed and assigned to a first render layer such as Render Layer A. Next, another item such as the item 702 may be selected to process. Since the item 702 is a non-interactive item and overlaps with the non-interactive item 701, the item 702 may be assigned to the same render layer as the item 701. For example, the item 702 may also be assigned to Render Layer A with the item 701. Afterwards, another item such as the item 703 may be selected to process. Since the item 703 is an interactive item, the item 703 may be assigned to a separate render layer such as Render Layer B.

Additionally, the item 704 may be assigned to a separate render layer such as Render Layer C, since the item 704 is a non-interactive item and does not overlap with any other non-interactive items in the document 720. The item 705 may also be assigned to a separate render layer such as the Render Layer D, since the item 705 is a non-interactive item and does not overlap with any other non-interactive items in the document 720. Even if the item 705 overlaps with the item 703, the item 705 may not be assigned to the same render layer as the item 703 since the item 703 is an interactive item.

Similar to the processing of the item 703, the interactive items 706 and 707 may each be assigned to a separate render layer. For example, the item 706 may be assigned to Render Layer E, and the item 707 may be assigned to Render Layer F. The item 708 may be assigned to the same render layer as the item 702, since the item 708 is a non-interactive item and overlaps with the non-interactive item 702. For example, the item 708 may be assigned to Render Layer A as the item 702.

In some embodiments, the items 701-708 may be processed in sequence as described above. Alternatively, in some embodiments, the items 701-708 may be processed in parallel. For example, the interactive items 703, 706, and 707 may each be assigned to a separate render layer at the same time. Since the item 702 overlaps with the item 701 and the item 708, the items 701, 702, and 708 may be assigned to the same render layer such as Render Layer A simultaneously.

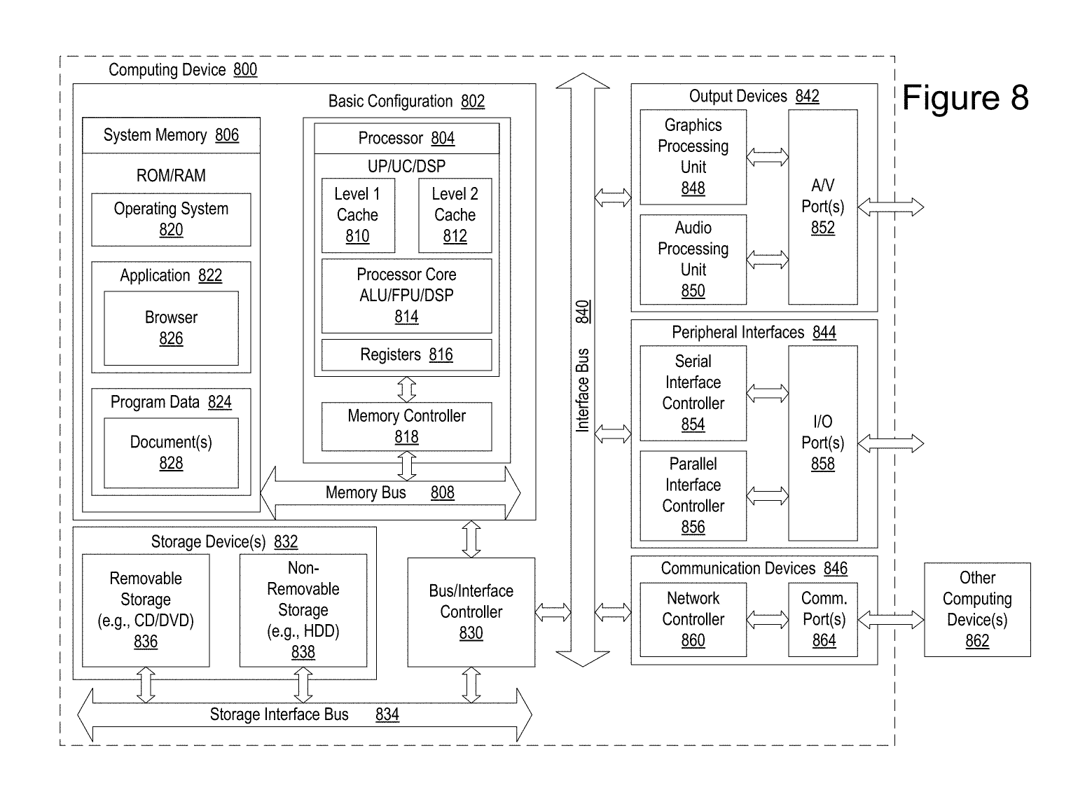

FIG. 8 is a block diagram illustrating an example computing device 800 that is arranged for managing documents, in accordance with at least some embodiments described herein. The computing device 800 may be included in or correspond to any of the client devices 111, 119, 121, and/or the server 101 of FIG. 1, for example. In a very basic configuration 802, the computing device 800 may typically include one or more processors 804 and a system memory 806. A memory bus 808 may be used for communicating between the processor 804 and the system memory 806.

Depending on the desired configuration, the processor 804 may be of any type including, but not limited to, a μP, a μC, a DSP, or any combination thereof. The processor 804 may include one or more levels of caching, such as a level one cache 810 and a level two cache 812, a processor core 814, and registers 816. The example processor core 814 may include an arithmetic logic unit (ALU), a floating point unit (FPU), a digital signal processing core (DSP core), or any combination thereof. An example memory controller 818 may also be used with the processor 804, or in some implementations the memory controller 818 may be an internal part of the processor 804.

Depending on the desired configuration, the system memory 806 may be of any type including, but not limited to, volatile memory (such as RAM), non-volatile memory (such as ROM, flash memory), or any combination thereof. The system memory 806 may include an operating system (OS) 820, one or more applications 822, and program data 824. The application 822 may include a browser 826, an app, an application server, or other application that may be arranged to perform one or more of the functions as described herein including those described with respect to the methods 200, 300, 400, and/or 500 of FIGS. 2-5. The program data 824 may include document(s) 828 that may be pulled into the browser 826 for management (e.g., creation, editing, interaction, publication, rendering) on one of the client devices 111, 119, 121 of FIG. 1, for example. In these and other examples, the program data 824 may also include scroll boxes that may be added to the documents 828 using the browser 826 or another application on the client devices 111, 119, 121 of FIG. 1. In some embodiments, the application 822 may be arranged to operate with the program data 824 on the OS 820 such that implementations of methods for creating documents with scroll boxes and/or for managing documents with scroll boxes such as the methods 200, 300, 400, and 500 of FIGS. 2-5 may be provided as described herein.

The computing device 800 may have additional features or functionality, and additional interfaces to facilitate communications between the basic configuration 802 and any required devices and interfaces. For example, a bus/interface controller 830 may be used to facilitate communications between the basic configuration 802 and one or more data storage devices 832 via a storage interface bus 834. The data storage devices 832 may be removable storage devices 836, non-removable storage devices 838, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer-readable instructions, data structures, program modules, or other data.

The system memory 806, removable storage devices 836, and non-removable storage devices 838 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 800. Any such computer storage media may be part of the computing device 800.

The computing device 800 may also include an interface bus 840 for facilitating communication from various interface devices (e.g., output devices 842, peripheral interfaces 844, and communication devices 846) to the basic configuration 802 via the bus/interface controller 830. Example output devices 842 include a graphics processing unit 848 and an audio processing unit 850, which may be configured to communicate to various external devices such as a display or speakers via one or more A/V ports 852. Example peripheral interfaces 844 include a serial interface controller 854 or a parallel interface controller 856, which may be configured to communicate with external devices such as input devices (e.g., keyboard, mouse, pen, voice input device, touch input device) or other peripheral devices (e.g., printer, scanner) via one or more I/O ports 858. The example communication device 846 may include a network controller 860, which may be arranged to facilitate communications with one or more other computing devices 862 over a network communication link via one or more communication ports 864.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media as used herein may include both storage media and communication media.

The computing device 800 may be implemented as a portion of a small-form factor portable (or mobile) electronic device such as a cell phone, a personal data assistant (PDA), a personal media player device, a wireless web-watch device, a personal headset device, an application-specific device, or a hybrid device that includes any of the above functions. The computing device 800 may also be implemented as a personal computer including both laptop computer and non-laptop computer configurations.

The present disclosure is not to be limited in terms of the particular embodiments described herein, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that the present disclosure is not limited to particular methods, reagents, compounds, compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method to interact with a scroll box in a document, the method comprising:
receiving data indicating a navigation in a scroll box of a document;
determining a scroll offset associated with the navigation;
determining a scroll stop location that corresponds to the scroll offset in the scroll box;
determining whether the scroll stop location is associated with a first stop object in the scroll box; and
in response to the scroll stop location not being associated with the first stop object:
determining a second stop object preceding the scroll stop location in the scroll box;
configuring the second stop object to appear in the scroll stop location; and
rendering a set of content within a view frame of the scroll box, the set of content including the second stop object and a subset of scroll-box content starting from the scroll stop location.

2. The method of claim 1, wherein the second stop object is rendered at a top section of the view frame.

3. The method of claim 1, wherein the second stop object is a header.

4. The method of claim 1, wherein the navigation includes one of an upward scrolling operation and a downward scrolling operation performed in the scroll box.

5. The method of claim 1, wherein receiving data indicating a navigation in a scroll box of the document comprises receiving input effective to scroll through content of the scroll box in the view frame, the view frame being smaller than the content, the method further comprising selectively rendering stop objects as headers associated with a plurality of sections of the content at a top of the view frame as the content of the scroll box scrolls, including:
determining that the scroll stop location in the view frame of the scroll box is in a first section of content that includes the first stop object comprising a first header, the first section of content being larger than the view frame such that only a portion of the first section of content is visible in the view frame at any given time when the scroll stop location is determined to be in the first section of content, the first header being located at a top of the first section of content;
rendering the first header at the top of the view frame so long as the scroll stop location in the view frame of the scroll box is determined to be in the first section of content, including rendering the first header at the top of the view frame when the scroll stop location in the view frame is below the top of the first section of content while still being within the first section of content;
determining that the scroll stop location in the view frame of the scroll box is in a second section of content that includes the second stop object comprising a second header, the second section of content following the first section of content, the second section of content being larger than the view frame such that only a portion of the second section of content is visible in the view frame at any given time when the scroll stop location is determined to be in the second section of content, the second header being located at a top of the second section of content; and
rendering the second header at the top of the view frame so long as the scroll stop location in the view frame of the scroll box is determined to be in the second section of content, including rendering the second header at the top of the view frame when the scroll stop location in the view frame is below the top of the second section of content while still being within the second section of content.

6. The method of claim 1, further comprising:
receiving a request to add the scroll box in the document when the document is being edited;
adding the scroll box in the document in response to the request;
rendering the document in a scroll-box edit mode when the scroll box is being edited, the rendering in the scroll-box edit mode including rendering all contents within the scroll box as an active item for editing in a manner free from spatial bounds of the document and rendering other content in the document but outside the scroll box as one or more of inactive content, static content, and faded out content.

7. The method of claim 6, wherein the one or more inactive content, static content, and faded out content is part of the document restricted within the spatial bounds of one or more pages of the document, and the method further comprises:
receiving input data in the scroll-box edit mode;
editing the scroll box based on the input data; and
exiting the scroll-box edit mode to generate a revised document that includes a combination of the scroll box, all the contents within the scroll box, including any edited content based on the input data, and the other content outside the scroll box, which was previously rendered as the one or more of inactive content, static content, and faded out content.

8. The method of claim 1, wherein the document includes a set of items to be rendered, the set of items including multiple interactive items including the scroll box and multiple non-interactive items, the method further comprising:
assigning the set of items to a plurality of render layers, including:
assigning each interactive item to a separate render layer, each interactive item in each corresponding render layer being exclusive of all other content in the corresponding render layer to which each interactive item is assigned;
selecting a first non-interactive item from the set of items;
determining whether the first non-interactive item overlaps with a second non-interactive item of the set of items;
in response to determining that the first non-interactive item overlaps with the second non-interactive item, assigning the first non-interactive item and the second non-interactive item to a common render layer of the plurality of render layers; and
in response to determining that the first non-interactive item does not overlap with the second non-interactive item, assigning the first non-interactive item and the second non-interactive item to separate render layers of the plurality of render layers;
and
rendering the document based on the plurality of render layers.

9. The method of claim 1, further comprising:
receiving a request to add the scroll box in the document when the document is being edited;
adding the scroll box in the document in response to the request; and
publishing the document including the scroll box.

10. The method of claim 9, wherein publishing the document comprises:
packaging a render application with the document in a file, the render application configured to render the document; and
sending the file including the document and the render application to a publishing platform for publication.

11. An article of manufacture comprising a non-transitory computer storage medium having computer instructions stored thereon that are executable by a computing device to perform operations comprising:
receiving data indicating a navigation in a scroll box of a document;
determining a scroll offset associated with the navigation;
determining a scroll stop location that corresponds to the scroll offset in the scroll box;
determining whether the scroll stop location is associated with a first stop object in the scroll box; and
in response to the scroll stop location not being associated with the first stop object:
determining a second stop object preceding the scroll stop location in the scroll box;
configuring the second stop object to appear in the scroll stop location; and
rendering a set of content within a view frame of the scroll box, the set of content including the second stop object and a subset of scroll-box content starting from the scroll stop location.

12. The article of manufacture of claim 11, wherein the second stop object is rendered at a top section of the view frame.

13. The article of manufacture of claim 11, wherein the second stop object is a header.

14. The article of manufacture of claim 11, wherein the navigation includes one of an upward scrolling operation and a downward scrolling operation performed in the scroll box.

15. The article of manufacture of claim 11, wherein receiving data indicating a navigation in a scroll box of the document comprises receiving input effective to scroll through content of the scroll box in the view frame, the view frame being smaller than the content, the method further comprising selectively rendering stop objects as headers associated with a plurality of sections of the content at a top of the view frame as the content of the scroll box scrolls, including:
determining that the scroll stop location in the view frame of the scroll box is in a first section of content that includes the first stop object comprising a first header, the first section of content being larger than the view frame such that only a portion of the first section of content is visible in the view frame at any given time when the scroll stop location is determined to be in the first section of content, the first header being located at a top of the first section of content;
rendering the first header at the top of the view frame so long as the scroll stop location in the view frame of the scroll box is determined to be in the first section of content, including rendering the first header at the top of the view frame when the scroll stop location in the view frame is below the top of the first section of content while still being within the first section of content;
determining that the scroll stop location in the view frame of the scroll box is in a second section of content that includes the second stop object comprising a second header, the second section of content following the first section of content, the second section of content being larger than the view frame such that only a portion of the second section of content is visible in the view frame at any given time when the scroll stop location is determined to be in the second section of content, the second header being located at a top of the second section of content; and
rendering the second header at the top of the view frame so long as the scroll stop location in the view frame of the scroll box is determined to be in the second section of content, including rendering the second header at the top of the view frame when the scroll stop location in the view frame is below the top of the second section of content while still being within the second section of content.

16. The article of manufacture of claim 11, further comprising:
receiving a request to add the scroll box in the document when the document is being edited;
adding the scroll box in the document in response to the request;
rendering the document in a scroll-box edit mode when the scroll box is being edited, the rendering in the scroll-box edit mode including rendering all contents within the scroll box as an active item for editing in a manner free from spatial bounds of the document and rendering other content in the document but outside the scroll box as one or more of inactive content, static content, and faded out content.

17. The article of manufacture of claim 16, wherein the one or more inactive content, static content, and faded out content is part of the document restricted within the spatial bounds of one or more pages of the document, and the method further comprises:
receiving input data in the scroll-box edit mode;
editing the scroll box based on the input data; and
exiting the scroll-box edit mode to generate a revised document that includes a combination of the scroll box, all the contents within the scroll box, including any edited content based on the input data, and the other content outside the scroll box, which was previously rendered as the one or more of inactive content, static content, and faded out content.

18. The article of manufacture of claim 11, wherein the document includes a set of items to be rendered, the set of items including multiple interactive items including the scroll box and multiple non-interactive items, the method further comprising:
assigning the set of items to a plurality of render layers, including:
assigning each interactive item to a separate render layer, each interactive item in each corresponding render layer being exclusive of all other content in the corresponding render layer to which each interactive item is assigned;
selecting a first non-interactive item from the set of items;
determining whether the first non-interactive item overlaps with a second non-interactive item of the set of items;
in response to determining that the first non-interactive item overlaps with the second non-interactive item, assigning the first non-interactive item and the second non-interactive item to a common render layer of the plurality of render layers; and
in response to determining that the first non-interactive item does not overlap with the second non-interactive item, assigning the first non-interactive item and the second non-interactive item to separate render layers of the plurality of render layers; and
rendering the document based on the plurality of render layers.

19. A method to interact with a scroll box in a document, the method comprising:
receiving input effective to scroll through content of a scroll box having a view frame that is smaller than the content;
selectively rendering headers associated with a plurality of sections of the content at a top of the view frame as the content of the scroll box scrolls, including:
determining that a scroll stop location in the view frame of the scroll box is in a first section of content that includes a first header, the first section of content being larger than the view frame such that only a portion of the first section of content is visible in the view frame at any given time when the scroll stop location is determined to be in the first section of content, the first header being located at a top of the first section of content;
rendering the first header at the top of the view frame so long as the scroll stop location in the view frame of the scroll box is determined to be in the first section of content, including rendering the first header at the top of the view frame when the scroll stop location in the view frame is below the top of the first section of content while still being within the first section of content;
determining that the scroll stop location in the view frame of the scroll box is in a second section of content that includes a second header, the second section of content following the first section of content, the second section of content being larger than the view frame such that only a portion of the second section of content is visible in the view frame at any given time when the scroll stop location is determined to be in the second section of content, the second header being located at a top of the second section of content; and
rendering the second header at the top of the view frame so long as the scroll stop location in the view frame of the scroll box is determined to be in the second section of content, including rendering the second header at the top of the view frame when the scroll stop location in the view frame is below the top of the second section of content while still being within the second section of content;

20. An article of manufacture comprising a non-transitory computer storage medium having computer instructions stored thereon that are executable by a computing device to perform the method of claim 19.
